(19) United States
(12) Patent Application Publication
(10) Pub. No.: US 2013/0127841 A1
(43) Pub. Date: May 23, 2013

(54) THREE-DIMENSIONAL (3D) IMAGE DISPLAY METHOD AND APPARATUS FOR 3D IMAGING AND DISPLAYING CONTENTS ACCORDING TO START OR END OF OPERATION

(71) Applicant: SAMSUNG ELECTRONICS CO., LTD., Suwon-si (KR)

(72) Inventor: Hiromi TACHIBANA, Yokohama-si (JP)

(73) Assignee: SAMSUNG ELECTRONICS CO., LTD., Suwon-si (KR)

(21) Appl. No.: 13/680,610

(22) Filed: Nov. 19, 2012

(30) Foreign Application Priority Data
Nov. 18, 2011 (JP) 2011-252460
Jul. 20, 2012 (KR) 10-2012-0079589
Nov. 6, 2012 (KR) 10-2012-0125092

(51) Int. Cl. G06T 15/00

(52) U.S. Cl. CPC G06T 15/00
USPC 345/419

(57) ABSTRACT

A method of displaying contents performed by a display apparatus, the method including: displaying the contents according to a current operation mode; and when data for 3D display of an object is displayed, in a case where an operation is determined to end, displaying data for 2D display of the object on a display device, instead of the data for 3D display of the object.

CROSS-REFERENCE TO RELATED PATENT APPLICATIONS

This application claims priority from Korean Patent Application No. 10-2012-0125092, filed on Nov. 6, 2012, in the Korean Intellectual Property Office, Korean Patent Application No. 10-2012-0079589, filed on Jul. 20, 2012, in the Korean Intellectual Property Office and Japanese Patent Application No. 2011-252460, filed on Nov. 18, 2011, in the Japanese Patent Office, the disclosures of which are incorporated herein in their entirety by reference.

### BACKGROUND

1. Field

Methods and apparatuses consistent with exemplary embodiments relate to a method and apparatus for 3-dimensional (3D) imaging and displaying contents on a display apparatus capable of ending a 3D display of an unnecessary object when a user views the contents as an operation on the display apparatus or when a controller starts or ends.

2. Description of the Related Art

When contents are displayed on a display apparatus, if a part of the contents is set to be 3D imaged and displayed, the display apparatus may generate data for 3D imaging and displaying of the contents or receive the data from an external apparatus and perform 3D imaging and displaying of the contents.

However, if a part of the contents is always 3D imaged and displayed, a user may have difficulty in viewing another part of the contents that is not 3D imaged and displayed due to the part of the contents that is 3D imaged and displayed. For example, there is a case where the user views only subway service information of data broadcasting or information provided as news on a television or a case where the user views only an image reproduced on a browser. In this regard, the user has difficulty in viewing information or an image that is supposed to view when an object such as a menu or an icon that the user does not need or want to recognize is in a 3D imaging state. Thus, it is necessary to determine whether to perform 3D imaging and displaying of contents according to circumstances.

### SUMMARY

Exemplary embodiments provide a method and apparatus for 3-dimensional (3D) imaging and displaying contents on a display apparatus as an operation on the display apparatus or a controller starts or ends.

According to an aspect of an exemplary embodiment, there is provided a method of displaying contents performed by a display apparatus, the method including: displaying the contents according to a current operation mode; and when data for 3D display of an object is displayed, in a case where an operation is determined to end, displaying data for 2D display of the object on a display device, instead of the data for 3D display of the object.

The method may further include: when the data for 3D display of the object and the data for 2D display of objects other than the object are displayed, in a case where the operation is determined to end, displaying the data for 2D display of the object on the display device, instead of the data for 3D display of the object.

The object may be a menu that may be selected by a user.

When the data for 2D display of the object is changed to the data for 3D display of the object and displayed, the object may be 3D imaged and displayed sequentially.

The method may further include: generating 3D display data for performing 3D imaging and displaying of the object sequentially; and performing 3D imaging and displaying of the object sequentially by using the generated data every predetermined period of time.

The method may further include: when the data for 2D display of the object is changed to the data for 3D display of the object and displayed, in a case where there is data for performing 3D imaging and displaying of the object sequentially, performing 3D imaging and displaying of the object sequentially by using the data for performing 3D imaging every predetermined period of time.

The displaying of the data for 2D display of the object may include: displaying the object that is 3D imaged and displayed in a 2D manner sequentially.

The displaying of the data for 2D display of the object may include: calculating a movement distance between neighboring frames among frames for performing 3D imaging and displaying of the object; generating at least one or more pieces of data for displaying the 3D imaged object sequentially in a 2D manner according to a value obtained by dividing the movement distance by a number of frames that are to be displayed sequentially; and performing 2D imaging and displaying of the 3D imaged object sequentially by using the at least one or more pieces of generated data every predetermined period of time.

The displaying of the data for 2D display of the object may include: determining whether there is data for performing 2D imaging and displaying of the object sequentially; and if it is determined that there is the data for performing 2D imaging and displaying of the object sequentially, performing 2D imaging and displaying of the object that is 3D imaged and displayed sequentially by using the data for performing 2D imaging every predetermined period of time.

According to another aspect of an exemplary embodiment, there is provided a computer readable recording medium having recorded thereon a program for executing the method above.

According to yet another aspect of an exemplary embodiment, there is provided a display apparatus comprising: a display device which displays contents; an outputter configured to control the display device to display data for display; and a determiner configured to determine whether an operation ends, wherein when data for 3D display of an object is displayed, in a case where the determining unit determines that the operation ends, data for 2D display of the object is displayed on the display device, instead of the data for 3D display of the object.

### BRIEF DESCRIPTION OF THE DRAWINGS

The above and other features and advantages of exemplary embodiments will become more apparent by describing in detail the attached drawings in which:

FIG. 1 is a block diagram of a system for displaying a 3-dimensional (3D) image according to whether an operation starts or ends, according to an exemplary embodiment;

FIG. 2 is a block diagram of a display apparatus for displaying a 3D image according to whether an operation starts or ends, according to an exemplary embodiment;

FIG. 3 is a flowchart of a method of generating display data, according to an exemplary embodiment;

FIG. 4 is a flowchart of a method of processing and displaying contents for display, according to an exemplary embodiment;

FIG. 5 is a flowchart of a method of changing an operation mode to a reading mode or the reading mode to the operation mode and sequentially 3D or 2D imaging and displaying contents;

FIGS. 6 and 7 are diagrams for explaining an example of 3D or 2D imaging and displaying an object focused in contents for display as an operation starts or ends, according to an exemplary embodiment; and

FIG. 8 is a diagram for explaining a method of changing an operation mode to a reading mode, or the reading mode to the operation mode and sequentially 3D or 2D imaging and displaying contents, according to an exemplary embodiment.

### DETAILED DESCRIPTION

Exemplary embodiments will now be described more fully with reference to the accompanying drawings. In the description of exemplary embodiments and the attached drawings, if it is determined that a detailed description of commonly-used technologies or structures related to the invention may unnecessarily obscure the subject matter of the invention, the detailed description will be omitted. In addition, it should be noted that like elements in the drawings are represented with like reference numerals.

The terms and the words used herein and in the claims should not be interpreted to be limited to a general or dictionary meaning but should be interpreted to have a meaning and concept that coincide with the technical spirit of the present invention based on the principle that the inventor can define his/her own invention by using terms for describing the invention in the best manner. Thus, the embodiments of the present invention and the drawings are just exemplary embodiments and do not represent all technical spirits of the present invention. Thus, it should be understood that there may be various equivalents and modification examples that may replace the exemplary embodiments at the time of filing the application.

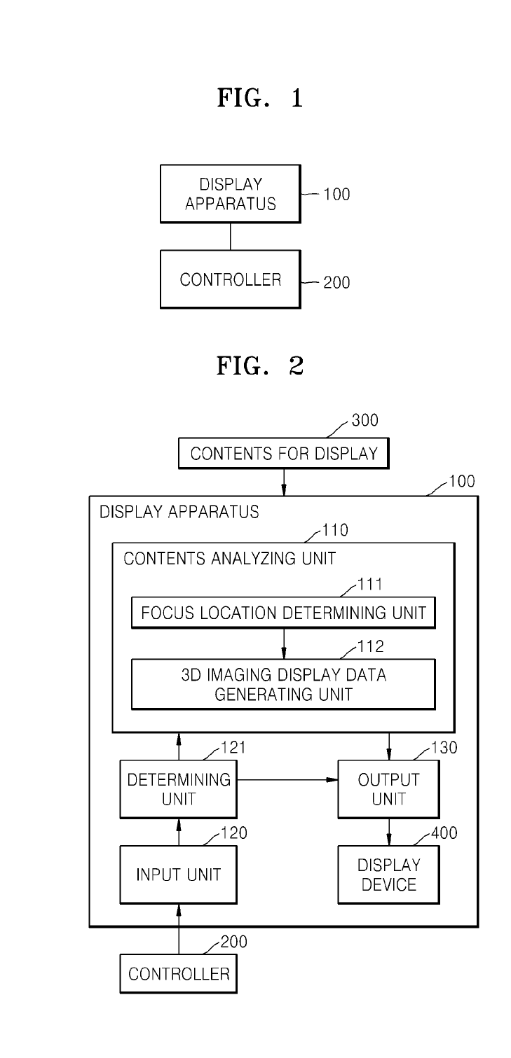

FIG. 1 is a block diagram of a system for displaying a 3-dimensional (3D) image according to whether an operation starts or ends, according to an exemplary embodiment.

Referring to FIG. 1, the system for displaying the 3D image according to whether the operation starts or ends according to an exemplary embodiment may include a display apparatus 100 and a controller 200.

The display apparatus 100 is an apparatus for 3D imaging and displaying contents, and may include a 3D TV, a 3D smart phone, and a 3D projector having a function of displaying a 3D image.

The controller 200 is for generating a user input signal used to control or operate the display apparatus 100 according to manipulation by a user, and may include a remote controller. The controller 200 may include one or more units of a key input unit, a touch input unit, a gesture input unit, and a sound input unit. The key input unit generates a signal corresponding to a key according to a key manipulation and includes a key pad and a key board. The touch input unit senses a user's touch of a specific part and recognizes an input operation, and includes a touch pad, a touch screen, and a touch sensor. The gesture input unit recognizes a user's designated motion, for example, a motion of shaking or moving a terminal, a motion of accessing the terminal, a motion of blinking eyes, etc., as a specific input signal, and includes one or more sensors of a terrestrial magnetic sensor, an acceleration sensor, a camera, an altimeter, a gyro sensor, and a proximity sensor.

The display apparatus 100 may determine whether to perform 3D imaging and displaying of the contents according to whether the input is received in the display apparatus 100 or the controller 200 and display the contents. In a case where a gesture input or a sound input is possible in the display apparatus 100 or the display apparatus 100 has both a function of displaying an image, like in the 3D smart phone, and a function of the controller 200, the system for displaying the 3D image according to an exemplary embodiment may not include the controller 200.

FIG. 2 is a block diagram of the display apparatus 100 for displaying a 3D image according to whether an operation starts or ends, according to an exemplary embodiment. Functional blocks related to exemplary embodiments are only shown in FIG. 2.

Referring to FIG. 2, the display apparatus 100 according to an exemplary embodiment may include a contents analyzing unit 110, an input unit 120, a determining unit 121, an output unit 130, and a display device 400.

The contents analyzing unit 110 may obtain contents for display 300 that is data for displaying contents on the display apparatus 100. The contents for display 300 may include data for displaying one or more objects. Objects may include a moving image, an image, text, and a menu button.

The contents analyzing unit 110 may analyze contents, specify an object of the contents to be 3D imaged and displayed, and generate display data of each object necessary for 3D imaging and displaying the specified object. In this regard, the contents analyzing unit 110 may specify an object of the contents that is set to be 3D imaged and displayed, or as a result of analyzing the contents, an object thereof may be focused on to be 3D imaged and displayed.

The contents analyzing unit 110 may include a focus location determining unit 111 and a 3D imaging display data generating unit 112.

The focus location determining unit 111 may specify the object of the contents that is to be 3D imaged and displayed as being focused. In a case where the object of the contents is already set to be 3D imaged and displayed, the object of the contents that is to be 3D imaged and displayed may be specified according to a setting. Also, the focus location determining unit 111 may analyze the contents and specify the part of the contents that is to be 3D imaged and displayed according to a predetermined standard as a result of analyzing the contents. For example, the focus location determining unit 111 may determine priority of objects included in the contents based on at least one of a usage frequency, importance, and a user preference, and specify an object having high priority as the part of the contents that is to be 3D imaged and displayed.

The 3D imaging display data generating unit 112 may generate data for displaying all objects of contents that are to be displayed on the display device 400 in a 2D manner and the data necessary for 3D imaging and displaying the object of the contents specified by the focus location determining unit 111. The data for 2D display is data for displaying an object in a 2D manner. The data for 3D display is data for displaying an object in a 3D manner. In a case where the data necessary for performing 3D or 2D imaging and displaying of the object of the contents is stored in an external apparatus or a storage unit (not shown) of the display apparatus 100, the 3D imaging display data generating unit 112 may not generate the data necessary to perform 3D imaging and displaying of the part of the contents. The data for 2D display of each object generated by the 3D imaging display data generating unit 112 and the data for 3D display of the focused object may be output to the output unit 130.

The input unit 120 is an interface for receiving an operation input from the user. For example, the input unit 120 may receive a user manipulation performed on the controller 200 through wireless communication such as infrared communication. Alternatively, the input unit 120 may receive an input of a user's gesture or sound. Also, the input unit 120 may be an input apparatus such as a key or button included in the display apparatus 100.

The determining unit 121 may receive an input signal from the display apparatus 100 or the controller 200 to determine whether the operation starts or ends, and determine whether to perform 3D imaging and displaying of the contents on the display device 400. In a case where the determining unit 121 determines whether the operation starts, the determining unit 121 may perform 3D imaging and displaying of the object being focused on, and determine to display an object that is not focused on in the 2D manner. In a case where the determining unit 121 determines whether the operation ends, the determining unit 121 may determine to display all objects in the 2D manner. Thus, in a case where the operation ends and the user reads the contents, the contents may be displayed in the 2D manner such that the user may view a part of the contents that is not 3D imaged.

The output unit 130 may control the display data generated by the 3D imaging display data generating unit 112 to be displayed on the display device 400. In a case where the determining unit 121 determines whether the operation starts, the output unit 130 may control the data for 3D display of the object that is focused on and the data for 2D display of the object that is not focused on to be output to the output unit 130 and displayed on the display device 400. Also, in a case where the determining unit 121 determines whether the operation ends, the output unit 130 may control the data for 2D display of all objects to be output to the output unit 130 and displayed on the display device 400.

The display device 400 is capable of 3D display by using the given 3D display method.

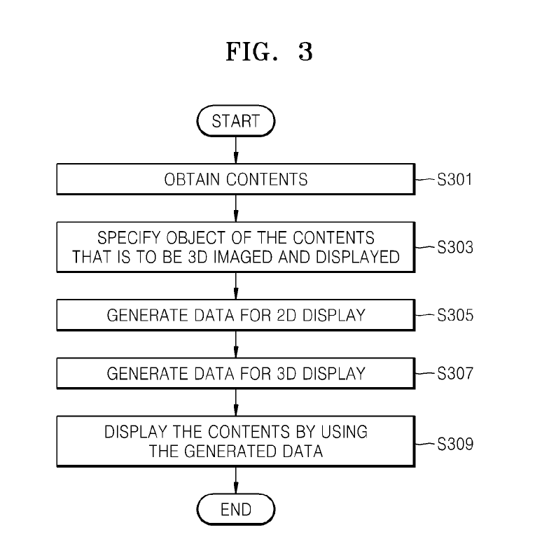

FIG. 3 is a flowchart of a method of generating display data, according to an exemplary embodiment.

The contents analyzing unit 110 of the display apparatus 100 may receive contents to be displayed through broadcasting or communication or obtain the contents from a storage device that is included therein but not shown or an external storage device such as a web server (operation 301).

In a case where the display apparatus 100 displays the contents for display 300 according to a user input, the focus location determining unit 111 of the display apparatus 100 may analyze the contents for display 300 and specify an object that is focused among objects included in the contents for display 300 (operation S303).

For example, the focus location determining unit 111 may specify an object (for example, a menu button, etc.) in which a focus target is described in the contents for display 300 as default.

Alternatively, the focus location determining unit 111 may specify a focus object based on a user's past input among the objects included in the contents for display 300. For example, the focus location determining unit 111 may memorize menu buttons determined by the determining unit 121 to have been selected by a user and selection numbers thereof. The focus location determining unit 111 may determine a menu button having high usage frequency as the focus object based on the selection number of each of the menu buttons memorized by the focus location determining unit 111.

Alternatively, in a case where the display apparatus 100 is currently in an operation mode that is a state where the user may operate contents and is in a state where 3D imaging is displayed on the display device 400, the focus location determining unit 111 may determine an object that is determined as an operation target by the determining unit 121 as the focus object based on a user's operation input to the input unit 120. For example, in a case where a predetermined menu button is selected by a user's input, the focus location determining unit 111 may determine the selected menu button as the focus object.

The 3D imaging display data generating unit 112 may generate data for displaying the objects of the contents for display 300 in a 2D manner (operation S305).

For example, in a case where the contents for display 300 is broadcasting contents, a moving image program of a channel that may be selected by the controller 200, a broadcasting weather forecast displayed as an image, news displayed as text data, a data broadcasting menu button, and an image or text data selected by a menu button may be objects that are to be displayed in the 2D manner or in a 3D manner used to generate data.

The 3D imaging display data generating unit 112 may generate data for 3D display by using data for 2D display of the specified data (operation S307).

The display device 400 may output the data for 2D display of all objects generated by the 3D imaging display data generating unit 112 and the data for 3D display of the focused object (operation S309).

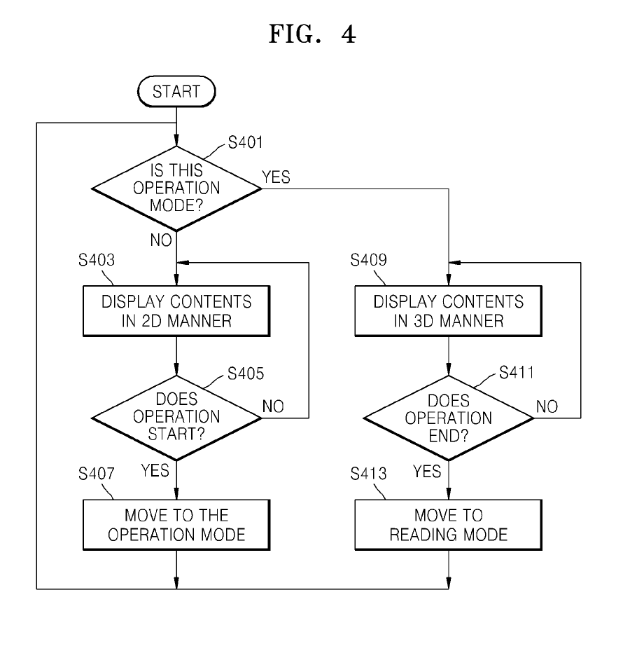

FIG. 4 is a flowchart of a method of processing and displaying contents for display, according to an exemplary embodiment.

The output unit 130 determines whether an initial state of the display apparatus 100 is currently an operation mode (operation S401). In this regard, the output unit 130 may optionally determine the initial state of the display apparatus 100 as an operation mode or a reading mode which is a state where a user does not operate. In a case where the output unit 130 determines that the initial state of the display apparatus 100 is the reading mode and is not the operation mode, the output unit 130 may control the display device 400 to output data for 2D display of each object generated by the 3D imaging display data generating unit 112 (operation S403). Accordingly, the display apparatus 100 may display contents that display all objects in a 2D manner.

If the determining unit 121 determines that an operation start is not input to the input unit 120 (operation S405), the display apparatus 100 may repeat operation S403.

If the determining unit 121 determines that the operation start is input to the input unit 120 (operation S405), the display apparatus 100 may change to the operation mode (operation S407) and display contents by using data for 3D display of objects of the contents. In this regard, like in the case where the user allows a pointer to be placed at a specific object or requests 3D imaging and display of the specific object, in a case where the determining unit 121 determines that a user's operation indicates an operation start with respect to the specific object, the display apparatus 100 may inform the focus location determining unit 111 of the specific object. Accordingly, in operation S303 of FIG. 3, the focus location determining unit 111 may specify the informed object as a focus target, and in operation S305 of FIG. 3, the 3D imaging display data generating unit 112 may generate data for 3D imaging and display of the informed object.

If the output unit 130 receives a 3D imaging and display request from the determining unit 121, the output unit 130 may determine that the display apparatus 100 changes to the operation mode and repeat operation S401. In this regard, the output unit 130 determines that the initial state of display of the display apparatus 100 is currently the operation mode (operation S401), and controls the display device 400 to display data for 3D display of the focused upon object generated by the 3D imaging display data generating unit 112 and data for 2D display of objects other than the focused upon object (operation S409). Thus, the display device 400 may display contents that display the focused object in the 3D manner and objects other than the focused object in the 2D manner.

The determining unit 121 determines whether the initial (e.g., current) state of display of the display apparatus 100 is an operation end (operation S411). In a case where the determining unit 121 determines that the initial state of display of the display apparatus 100 is not the operation end (operation S411), the display apparatus 100 may repeat operation S409.

In a case where the determining unit 121 determines that the initial state of display of the display apparatus 100 is the operation end (operation S411), the display apparatus 100 may change to the reading mode (operation S413) and request the output unit 130 to end 3D display of the contents.

The output unit 130 may repeat operation S401. Thus, the output unit 130 determines that the initial state of display of the display apparatus 100 is not currently the operation mode and may control the display device 400 to display the data for 2D display of each object generated by the 3D imaging display data generating unit 112 (operation S403). That is, the display apparatus 100 may display data for 2D display of a corresponding object on the display device 400 in the 2D manner, instead of data for 3D imaging and display of an object that was 3D imaged and displayed in the operation mode.

In this way, the display apparatus 100 may end the 3D imaging and display according to a user's instruction to end the operation and change to the reading mode.

In operation S409, in a case where the user inputs an operation start of another object, in operation S411, the determining unit 121 determines that the operation does not end and may inform the focus location determining unit 111 of the object whose operation start is newly instructed. The focus location determining unit 111 may specify the informed object as a focus target. The 3D imaging display data generating unit 112 may generate data for 3D imaging and display of the informed object. Thus, in operation S409, the display device 400 may display the data for 3D imaging and display the object whose operation start is newly instructed and data for 2D display of other objects including objects that have been 3D imaged and displayed up to now.

Examples of the user's operation determined by the determining unit 121 as the operation start in operation S405 are as follows.

(Operation a1) the user holds the controller 200 in his/her hand. For example, in a case where the controller 200 detects that the user holds the controller 200 in his/her hand based on a sensor included therein, the controller 200 may inform the input unit 120 of the display apparatus 100 of the detection so that the determining unit 121 may determine the operation start.

(Operation a2) the user makes a specific gesture in response to the operation start. In this case, the input unit 120 is a gesture input device. The determining unit 121 may determine the operation start from an analysis result of the gesture by the input unit 120.

(Operation a3) the user presses an operation start key of the controller 200. The controller 200 may inform the input unit 120 of the display apparatus 100 that the operation start key is pressed so that the determining unit 121 may determine the operation start.

(Operation a4) the user starts moving his/her hand in front of the display device 400. The input unit 120 may detect that his/her hand in front of the display device 400 starts moving. The determining unit 121 may determine the operation start from a detection result of the input unit 120.

(Operation a5) the user verbally instructs the operation start. In this case, the input unit 120 is a sound input device and outputs a sound recognition result of a user's vocalization to the determining unit 121. The determining unit 121 may determine the operation start from the sound recognition result of the input unit 120.

Also, examples of the user's operation determined by the determining unit 121 as the operation end in operation S411 are as follows.

(Operation b1) the user takes his/her hand from the controller 200. For example, in a case where the controller 200 detects that the user takes his/her hand from the controller 200 based on a sensor included therein, the controller 200 may inform the input unit 120 of the display apparatus 100 of the detection so that the determining unit 121 may determine the operation end.

(Operation b2) the user makes a specific gesture in response to the operation end. The determining unit 121 may determine the operation end from an analysis result of the gesture by the input unit 120 that is a gesture input device.

(Operation b3) the user presses an operation end key of the controller 200. The controller 200 may inform the input unit 120 of the display apparatus 100 that the operation end key is pressed. In addition, the determining unit 121 may determine an instruction to change to a reading mode or an instruction to operate objects other than a focus object that is currently displayed in the 3D manner as the operation ends with respect to the object that is currently displayed in the 3D manner.

(Operation b4) the user stops moving his/her hand in front of the display device 400. The input unit 120 may detect that his/her hand in front of the display device 400 stops moving. The determining unit 121 may determine the operation end from a detection result of the input unit 120.

(Operation b5) the user verbally instructs the operation end. The determining unit 121 may determine the operation end from a sound recognition result of the input unit 120, which is a sound input device.

(Operation b6) the user does not operate for a predetermined period of time. In a case where no operation is input for a previously determined period of time after an operation mode, the determining unit 121 may determine the operation end.

In a case where the 3D reproduction mode is changed to the 2D production mode or the 2D production mode is changed to the 3D production mode, if the contents are sequentially 3D or 2D imaged and displayed, a user may naturally view the contents without any afterimage. A method of 3D or 2D imaging and displaying contents sequentially will now be described.

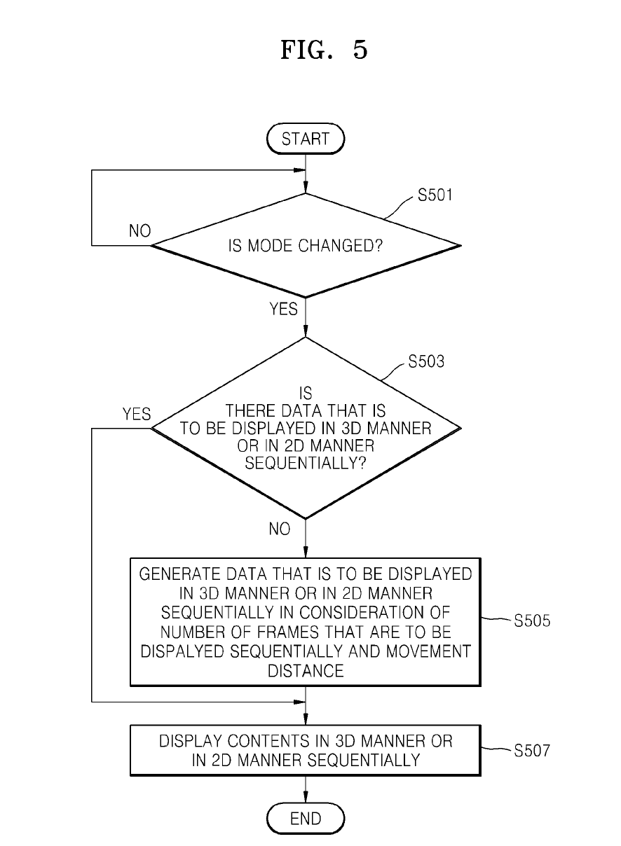

FIG. 5 is a flowchart of a method of changing an operation mode to a reading mode or the reading mode to the operation mode and sequentially 3D or 2D imaging and displaying contents.

In the case where it is determined that the operation mode is changed to the reading mode or the reading mode is changed to the operation mode (operation S501), and in the case where it is determined that data for 3D or 2D imaging and displaying the contents sequentially exists (operation S503), 3D or 2D imaging and displaying of the contents sequentially are performed using the data (operation S507).

In the case where it is determined that the operation mode is changed to the reading mode or the reading mode is changed to the operation mode (operation S501), and in the case where it is determined that data for 3D or 2D imaging and displaying the contents step by step does not exist (operation S503), the 3D imaging display data generating unit 112 may generate the data for 3D or 2D imaging and displaying the contents step by step in consideration of a movement distance between frames and the number of frames that are to be 3D imaged and displayed step by step between frames (operation S505).

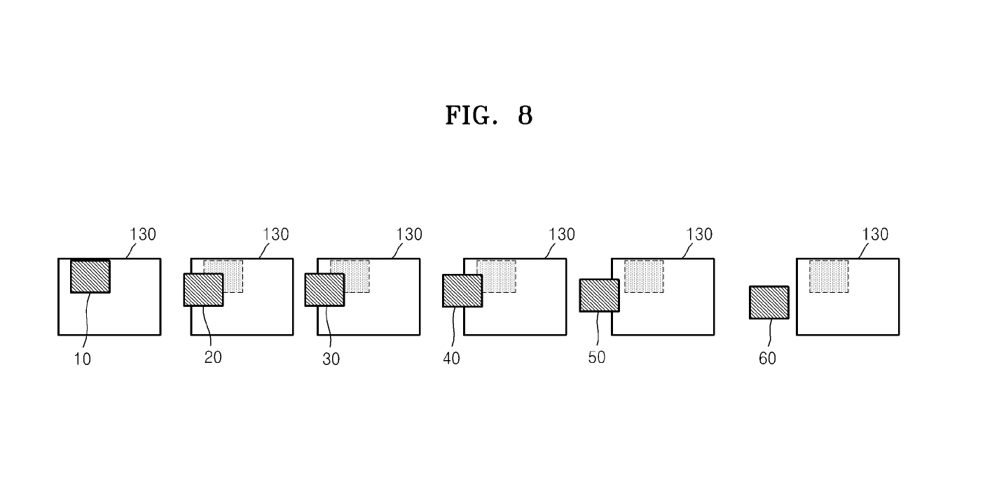

In more detail, the 3D imaging display data generating unit 112 may determine 3D imaging degrees of frames to be generated according to a value obtained by dividing a movement distance value between frames by the number of frames that are to be 3D imaged and displayed step by step between frames, and generate the data for 3D or 2D imaging and displaying the contents step by step. This will be described in more detail with reference to FIG. 8 below.

FIG. 8 is a diagram for explaining a method of changing an operation mode to a reading mode or the reading mode to the operation mode and sequentially 3D or 2D imaging and displaying contents, according to an exemplary embodiment.

Referring to FIG. 8, a frame 1 10 that is 2D imaged and a frame 2 60 that is 3D imaged may be displayed on the display device 400. When the operation mode is changed to the reading mode or the reading mode is changed to the operation mode, the display device 400 may change and display the frame 1 10 to the frame 2 60 or the frame 2 60 to the frame 1 10. In this regard, since there is a big difference in a 3D imaging degree between the frame 1 10 and the frame 2 60, when a user views the contents, an afterimage of a frame that was previously displayed remains, which gives the user a sense of incompatibility. Thus, if the contents are 3D or 2D imaged and displayed step by step, the user may naturally view the contents without any afterimage.

It is assumed that the 3D imaging degree of each frame is a length from the display device 400 to a most protruding part, the 3D imaging degree of the frame 1 10 is 0 cm, and the 3D imaging degree of the frame 2 60 is 50 cm. In this regard, the difference in the 3D imaging degree between the frame 1 10 and the frame 2 60 is 50 cm. The 3D imaging display data generating unit 112 may set the difference in the 3D imaging degree as a movement distance between frames and generate the data for 3D or 2D imaging and displaying the contents step by step by using the movement distance.

A value obtained by dividing the movement distance value by the number of frames that are to be 3D imaged and displayed step by step may be used to determine a difference value in the 3D imaging degree between the frames to be generated. Referring to FIG. 8, since the movement distance value is 50 cm, and the number of frames that are to be displayed step by step is 5, a value obtained by dividing 50 cm by 5, i.e. 10 cm, may be the difference value in the 3D imaging degree between the frames to be generated. Thus, a frame 3 20, a frame 4 30, a frame 5 40, and a frame 6 50 that are 3D images at intervals of 10 cm may be generated as the data used to perform 3D or 2D imaging and displaying of the contents step by step.

Referring back to FIG. 5, the display device 400 may use the data generated by the 3D imaging display data generating unit 112 to display the frames at predetermined time intervals, thereby 3D imaging and displaying the contents step by step (operation S505).

In this regard, the number of frames that are 3D imaged and displayed step by step between the frames and the time intervals used to perform the 3D imaging and displaying of the generated data step by step may be determined according to user settings or values of the number of frames and time intervals when the user naturally views the contents that are 3D or 2D imaged and displayed.

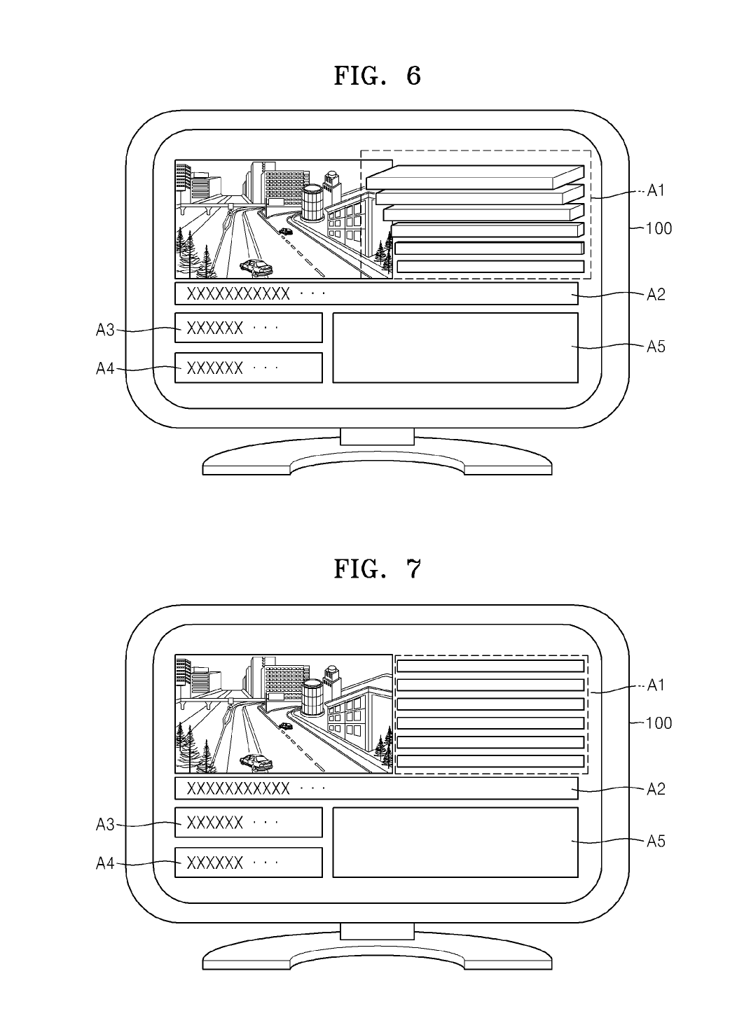

FIGS. 6 and 7 are diagrams for explaining an example of 3D or 2D imaging and displaying an object focused in contents for display as an operation starts or ends, according to an exemplary embodiment. In FIGS. 6 and 7, data broadcasting on a TV is displayed as contents.

Referring to FIGS. 6 and 7, a specific part of the contents for display that is to be 3D imaged and displayed may be 2D or 3D imaged and displayed according to whether the operation starts or ends.

As shown in FIG. 6, when a user operates contents, a menu button A1 that is the focused object may be displayed on the display device 400 in a 3D manner, and other objects may be displayed in a 2D manner. The user selects and operates the menu button A1 by using the controller 200 so that information selected by the user is displayed on information display areas A2, A3, A4, and A5 in a lower portion of the menu button A1. In this case, the user may sequentially view the information displayed on the information display areas A2, A3, A4, and A5 in the lower portion of the menu button A1.

In a case where the user stops operating the menu button A1 in the way or the menu button A1 is displayed as a default in a 3D manner, the user may sequentially view the information displayed on the information display areas A2, A3, A4, and A5.

However, this is a state where the menu button A1 is 3D imaged and information that the user does not need is displayed ahead, which may make it difficult for the user to view the information displayed on the information display areas A2, A3, A4, and A5.

Therefore, like (operation b6) described above, in a case where the determining unit 121 determines that the user does not operate a controller, the determining unit 121 may determine an operation end, i.e., a state in which contents are read is a reading mode. In this regard, the display apparatus 100 moves the reading mode according to the operation end. The output unit 130 may control the display device 400 to display every piece of contents in a 2D manner as shown in FIG. 7.

Thus, the display apparatus 100 changes a 3D display to a 2D display, and thus an unnecessary observation is avoided, and information desired by the user may be easily viewed.

In addition, as shown in FIG. 6, when the menu button A1 is displayed in the 3D manner, in a case where the user operates the controller 200 other than a selection operation of the menu button A1 like an instruction of the reading mode (operation b3), the determining unit 121 may determine the operation end of the menu button A1 and request the output unit 130 to change to the reading mode.

Although a case where the display apparatus 100 is a TV is described above, if the display apparatus 100 is a computer, the contents for display 300 may be data that may be displayed on a browser. Also, if the display apparatus 100 is a game machine, the contents for display 300 may be screen data like a game condition setting screen.

According to the above-described exemplary embodiments, the display apparatus 100 may start or end a 3D display according to a user's operation start or end. That is, the display apparatus 100 exchanges the 3D display and a 2D display, thereby expressing the operation start or end to the user without changing an original color or layout of contents. In a case where the operation ends, the display apparatus 100 ends 3D display of an object that is an operation target, thereby preventing the user from observing unnecessary information and displaying information desired by the user so that the user may easily view the information.

The above-described display apparatus 100 may include a computer system therein. The operations of the content analyzing unit 110, the determining unit 121, and the output unit 130 of the display apparatus 100 may be recorded in a computer readable recording medium in program forms, and may be performed by reading and executing the programs in the computer system. The computer system herein may include hardware such as a CPU, various types of memory, an OS, peripheral devices, and the like.

Exemplary embodiments may also be embodied as computer (including all devices having the function of image processing) readable codes on a computer readable recording medium. The computer readable recording medium is any data storage device that can store data that can be thereafter read by a computer system. Examples of the computer readable recording medium include read-only memory (ROM), random-access memory (RAM), CD-ROMs, magnetic tapes, floppy disks, optical data storage devices, etc.

While exemplary embodiments have been particularly shown and described, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description but by the appended claims, and all differences within the scope will be construed as being included in the present invention.

What is claimed is:

1. A method of displaying contents performed by a display apparatus, the method comprising:
displaying the contents according to a current operation mode; and
when data for 3D display of an object is displayed, in a case where an operation is determined to end, displaying data for 2D display of the object on a display device, instead of the data for 3D display of the object.

2. The method of claim 1, further comprising: when the data for 3D display of the object and the data for 2D display of objects other than the object are displayed, in a case where the operation is determined to end, displaying the data for 2D display of the object on the display device, instead of the data for 3D display of the object.

3. The method of claim 1, wherein the object is a menu that may be selected by a user.

4. The method of claim 1, wherein when the data for 2D display of the object is changed to the data for 3D display of the object and displayed, the object is 3D imaged and displayed sequentially.

5. The method of claim 4, further comprising:
generating 3D display data for performing 3D imaging and displaying of the object sequentially; and
performing 3D imaging and displaying of the object sequentially by using the generated data every predetermined period of time.

6. The method of claim 4, further comprising: when the data for 2D display of the object is changed to the data for 3D display of the object and displayed, in a case where there is data for performing 3D imaging and displaying of the object sequentially, performing 3D imaging and displaying of the object sequentially by using the data for performing 3D imaging every predetermined period of time.

7. The method of claim 2, wherein the displaying of the data for 2D display of the object comprises: displaying the object that is 3D imaged and displayed in a 2D manner sequentially.

8. The method of claim 7, wherein the displaying of the data for 2D display of the object comprises:
calculating a movement distance between neighboring frames among frames for performing 3D imaging and displaying of the object;
generating at least one or more pieces of data for displaying the 3D imaged object sequentially in a 2D manner according to a value obtained by dividing the movement distance by a number of frames that are to be displayed sequentially; and
performing 2D imaging and displaying of the 3D imaged object sequentially by using the at least one or more pieces of generated data every predetermined period of time.

9. The method of claim 7, wherein the displaying of the data for 2D display of the object comprises:
determining whether there is data for performing 2D imaging and displaying of the object sequentially; and
if it is determined that there is the data for performing 2D imaging and displaying of the object sequentially, performing 2D imaging and displaying of the object that is 3D imaged and displayed sequentially by using the data for performing 2D imaging every predetermined period of time.

10. A display apparatus comprising:
a display device which displays contents;
an outputter configured to control the display device to display data for display; and
a determiner configured to determine whether an operation ends,
wherein when data for 3D display of an object is displayed, in a case where the determining unit determines that the operation ends, data for 2D display of the object is displayed on the display device, instead of the data for 3D display of the object.

11. The display apparatus of claim 10, wherein when the data for 3D display of the object and data for 2D display of objects other than the object are displayed, in a case where the determining unit determines that the operation ends, the output unit controls the display device to display the data for 2D display of the object, instead of the data for 3D display of the object.

12. The display apparatus of claim 10, wherein the object is a menu that may be selected by a user.

13. The display apparatus of claim 10, wherein when the data for 2D display of the object is changed to the data for 3D display of the object and displayed on the display device, the output unit controls the object to be 3D imaged and displayed sequentially.

14. The display apparatus of claim 13, further comprising: a 3D imaging display data generator configured to calculate a movement distance between neighboring frames among frames for performing 3D imaging and displaying of the object and generating at least one or more pieces of data for performing 3D imaging and displaying of the object sequentially according to a value obtained by dividing the movement distance by a number of frames that are to be displayed sequentially, wherein the outputter controls the display device to perform 3D imaging and displaying of the object sequentially by using the at least one or more pieces of generated data every predetermined period of time.

15. The display apparatus of claim 13, wherein in a case where there is data for performing 3D imaging and displaying of the object sequentially, the outputter controls the display device to perform 3D imaging and displaying of the object sequentially by using the data every predetermined period of time.

16. The display apparatus of claim 11, wherein the outputter controls the display device to display the object that is 3D imaged and displayed sequentially in a 2D manner.

17. The display apparatus of claim 16, further comprising: a 3D imaging display data generator configured to calculate a movement distance between neighboring frames among frames for performing 3D imaging and displaying of the object and generate at least one or more pieces of data for displaying the object that is 3D imaged sequentially in a 2D manner according to a value obtained by dividing the movement distance by a number of frames that are to be displayed sequentially, wherein the output unit controls the display device to perform 2D imaging and displaying of the object that is 3D imaged sequentially by using the at least one or more pieces of generated data every predetermined period of time.

18. The display apparatus of claim 16, wherein in a case where there is data for performing 2D imaging and displaying of the object sequentially, the outputter controls the display device to perform 2D imaging and display of the object that is 3D imaged sequentially by using the data every predetermined period of time.

19. A computer readable recording medium having recorded thereon a
program for executing the method of displaying a 3D image performed by a display apparatus, the method comprising:
displaying the contents according to a current operation mode; and
when data for 3D display of an object is displayed, in a case where an operation is determined to end, displaying data for 2D display of the object on a display device, instead of the data for 3D display of the object.
